(19) United States
(12) Patent Application Publication
(10) Pub. No.: US 2013/0067890 A1
(43) Pub. Date: Mar. 21, 2013

(54) METHOD OF OPTIMIZING OPERATING COSTS OF AN INTERNAL COMBUSTION ENGINE

(71) Applicants: Joseph J. Michalek, Redford, MI (US); Rakesh K. Aneja, Novi, MI (US)

(72) Inventors: Joseph J. Michalek, Redford, MI (US); Rakesh K. Aneja, Novi, MI (US)

(73) Assignee: Detroit Diesel Corporation, Detroit, MI (US)

(21) Appl. No.: 13/236,958

(22) Filed: Sep. 20, 2011

(51) Int. Cl. F01N 3/18; G06F 19/00; F01N 9/00

(52) U.S. Cl. 60/274; 60/286; 701/115

(57) ABSTRACT

A method to optimize operation of a diesel fuel engine having at least one aftertreatment device to reduce NOx is provided. An electronic control unit for a diesel engine with an aftertreatment device for the reduction of NOx is also provided. The method and the control unit optimize a quantity of fuel to be injected into an aftertreatment device based upon inputs relating to the cost of diesel fuel and the cost of diesel exhaust fluid.

### TECHNICAL FIELD

Emissions regulations relating to internal combustion engines, including diesel engines, are increasingly stringent. This trend is expected to continue. These stringent regulations often impart expenses on engine manufacturers to find new methods and systems to satisfy the obligations. Additionally, manufacturers must reconsider how to correctly analyze the operating costs of an engine that has been modified with a new method or system. For example, when an aftertreatment device such as selective catalytic reduction (SCR) is used with a diesel engine, one of the cost considerations relates to the fluctuation in price of diesel fuel relative to diesel exhaust fluid (DEF). In addition, the fuel used to heat the Diesel Particulate Filter (DPF) and fuel consumed during regeneration must be considered. It is known that increased temperatures necessary to effect regeneration of the DPF have a deleterious effect on the useful life of the DPF. Accordingly, the effect of the increased exhaust temperatures on the DPF must also be considered. Thus, it is well understood that operating costs relate not just to the consumption of fuel, but also to the consumption of DEF.

The present disclosure relates to methods and controllers for engines that are adapted to be used with one ore more aftertreatment devices to achieve lower operational costs when diesel fuel and DEF are used.

Many approaches have been used to reduce emissions to satisfy government regulations. This includes modifications to engines as well as to aftertreatment devices.

One common engine modification for NOx reduction is exhaust gas recirculation (EGR). EGR diverts a portion of an engine's exhaust gas into the engine cylinders. The exhaust gas is inert and its presence prevents more combustible material (e.g., oxygen) from being in the cylinders by displacing the combustible material. As a result, when combustion occurs, it does not reach temperatures as high as it would in the absence of the recirculated exhaust gas. Because the burned gas temperature of EGR combustion is lower, less NOx is formed in engines using EGR. One exemplary EGR system is disclosed in U.S. Pat. No. 7,213,553 assigned to Detroit Diesel Corporation, which is incorporated by reference herein in its entirety. Whether or not EGR is used, the exhaust that leaves the engine contains a certain amount of what is referred to herein as “engine-out NOx.” The greater the EGR usage, the lower the engine-out NOx.

Aftertreatment devices are frequently used in exhaust systems with diesel engines to reduce emissions. Aftertreatment devices can be used in combination with EGR, but one does not require the other. Aftertreatment devices in the exhaust system are generally used to treat exhaust streams from engines containing engine-out NOx. When the exhaust stream has made it through all of the aftertreatment devices, the remaining exhaust gas runs through the tailpipe to the atmosphere. Government standards are concerned with tailpipe emissions.

One aftertreatment device is an SCR. In exhaust systems so equipped, engine exhaust gas flow containing engine-out NOx runs through an SCR canister, which contains urea and catalyst. Currently, in diesel engines, the grade of urea that is commonly used is also referred to DEF. A commonly used DEF is an organic, non-toxic compound made of about 32.5% urea and about 67.5% deionized water. Additional reducing agents may optionally be included. When NOx in the reacts with DEF, NOx is chemically reduced to nitrogen and water and a small amount of carbon dioxide. One exemplary SCR system is disclosed in U.S. Pat. No. 6,901,748 assigned to Detroit Diesel Corporation, which is incorporated by reference herein in its entirety.

Another commonly used aftertreatment device is a diesel oxidation catalyst (DOC) system. DOC can be used in combination with an SCR. As exhaust gas flows through a DOC canister having interior walls coated with a catalyst containing metals such as platinum or palladium, it contacts the catalyst layer, which causes a chemical oxidation reaction with the constituent gasses in the exhaust stream wherein carbon monoxide and other hydrocarbons are catalyzed to give products of carbon dioxide and water. A DOC is included in the description of U.S. Pat. No. 7,343,736 assigned to Detroit Diesel Corporation, which is incorporated by reference herein in its entirety.

Another commonly used aftertreatment device is a diesel particulate filter (DPF) system. DPF systems are commonly used together with one or both of SCR and DOC. DPFs are filters through which exhaust runs and through which particulates, hydrocarbons and soot cannot readily pass. There are single-use disposable DPFs and reusable DPFs. In some reusable DPFs, a filter may be cleaned or regenerated. Regeneration can occur through increasing engine speed or load, or both, during engine operation so that the temperature of the exhaust gas is increased. The increased exhaust gas temperature may be used in conjunction with a hydrocarbon (HC) doser that injects fuel into the DPF. During a DPF regeneration event, the elevated exhaust temperature causes the HC injected fuel to ignite and combust the soot and HC to regenerate the DPF. A suitable DPF (along with at least one DPF maintenance procedure) is described in U.S. Pat. No. 7,650,781 assigned to Detroit Diesel Corporation, which is incorporated by reference herein in its entirety.

An SCR, DOC and DPF may be arranged in the exhaust system in multiple manners, with one or more of the devices excluded. A typical arrangement is for an engine to recirculate a portion of the exhaust via EGR and to send the remaining portion of the exhaust out of a pipe where it is only periodically dosed with hydrocarbons (HCs), but always sent through a DOC canister, then sent through a DPF, then the exhaust is dosed with DEF and sent through an SCR canister for the reduction reaction to occur. The products of the SCR canister are then released to atmosphere.

It is desired to use one or more aftertreatment devices to achieve emissions standards in the most cost-efficient manner, and to accommodate for variations in price both for diesel fuel and for DEF when at least one of the aftertreatment devices is an SCR.

### SUMMARY

It has been discovered that the cost effectiveness of a diesel engine operation that uses an SCR aftertreatment device is sensitive to the price ratio of diesel fuel to DEF. Thus, methods and controllers have been developed relating to optimizing the cost effectiveness of NOx reduction based at least in part upon the price ratio of diesel fuel to DEF, hereinafter referred to as “cost ratio” or “CR.”

A method of using a controller to optimize operation of a diesel engine for lowest possible costs is provided. One such method includes receiving input data regarding diesel fuel cost and regarding cost of DEF. The method also includes determining a target engine-out NOx emission level based upon at least the diesel fuel cost input and the DEF cost input using an electronic engine control module. The method then calls for the use of the engine-out NOx emission target level to determine a quantity of DEF to be injected into an aftertreatment device such that all applicable exhaust emissions regulations are satisfied or exceeded. The method also calls for, in fact, causing the determined quantity of DEF to be injected.

An electronic control unit (ECU) is also provided. The ECU includes means for receiving input data regarding diesel fuel cost and cost data for DEF. The ECU also includes means for determining an optimal desired engine-out NOx emission level based upon at least the diesel fuel cost input, the DEF cost input, the net change in diesel fuel required by the HC doser and the overall balance of energy consumed by the engine to deliver the expected output power. The overall balance of energy consumed by the engine is related but not limited to air volume requirements for an air assisted DEF dosing system, the change in engine heat rejection caused by the shift in NOx emissions levels and the effects on other parasitic devices that are driven by the engine. The ECU also includes means for determining a quantity of DEF to be injected into the aftertreatment device to achieve the target engine-out NOx emission level.

### BRIEF DESCRIPTION OF THE DRAWINGS

FIG. 1 is a schematic of an engine including EGR, DOC, DPF and SCR.

FIG. 2 is a method for optimizing engine operation costs for diesel engines used with SCR.

FIG. 3 is a schematic of a system for use with the method of FIG. 2.

FIG. 4 is a plot showing the impact of the CR of diesel fuel to DEF on target engine-out NOx values.

### DETAILED DESCRIPTION

The figures herein are used to describe exemplary embodiments of the claimed subject matter and are not intended to be limiting to the scope and sprit of the invention as set forth in the appended claims.

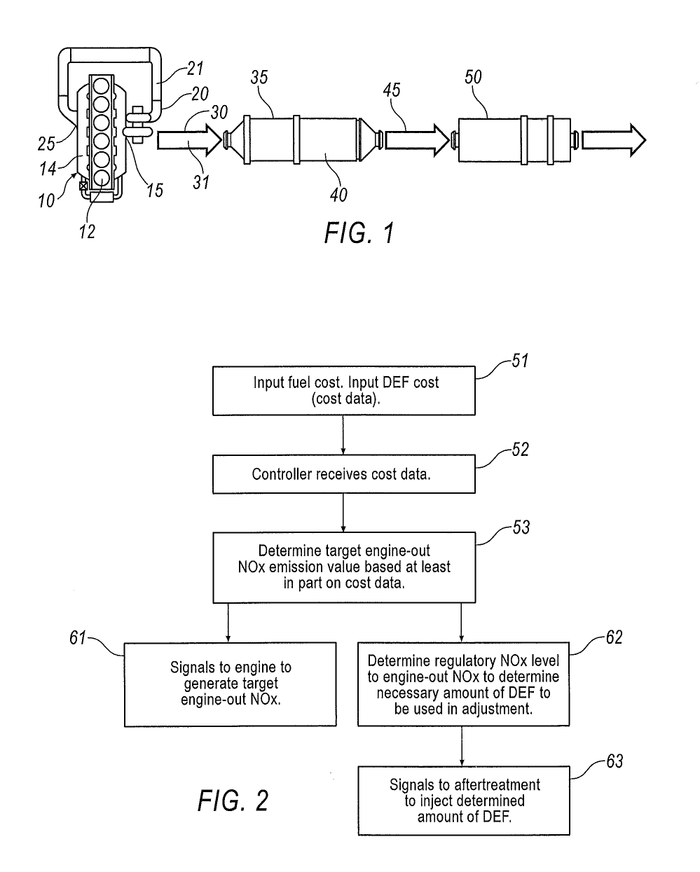

FIG. 1 refers to engine 10 that has been modified to include EGR. Engine 10 is equipped with at least one cylinder 12 for reciprocating movement with block 14 as is well known in the art. Engine 10 has an exhaust port 15 in communication with pipe 20. A predetermined portion of the exhaust 21 that escapes through exhaust port 15 is introduced to pipe 20 during an exhaust process in a two-cycle or four-cycle engine. In pipe 20, exhaust 21 is circulated and the temperature of the exhaust 21 is modified (typically reduced) according to known methods to be within a predetermined temperature range. Then, the exhaust 21 is reintroduced to the engine through an inlet port 25.

The remainder of the exhaust 21 that is not introduced to pipe 20 is exposed to a hydrocarbon (HC) doser 30. The HC doser is used to periodically inject a predetermined amount of fuel 31 into the exhaust 21. The period can be based on selection of a predetermined time, and/or it can be determined using a controller based on any number of factors including inputs from pressure sensors. If a controller determines that it is necessary to burn accumulated HC and soot out of a DPF 40 (also known as regenerating DPF 40), the controller can cause the HC doser to dose the exhaust 21 with diesel fuel. Generally, when it is desired to initate a regernation event, the engine speed or load, or both, are increased and the temperature of the exhaust gas stream produced is thereby increased. The engine speed is controlled by fueling strategies that vary the quantity and timing of the fuel injected into the combustion chambers of the engine. The resultant exhaust has an elevated temperature into which the HC doser introduces a quantity of fuel, such that the exhaust stream in dosed. The increased temperature exhaust gas/HC dosed exhaust gas mixture (the mixture) passes through a DOC 35 to burn off HC and soot in DPF 40. The reason HC and soot accumulate in DPF 40 is that DPF 40 typically has honeycomb porous walls (not shown) through which non-particulate matter is designed to flow. Particulate matter, then, accumulates in the walls. When too much HC or soot accumulates such that engine performance and/or emissions are impacted, then DPF 40 needs to be regenerated as described.

The filtered mixture is then exposed to a DEF doser 45 where DEF 46 is added to react with and reduce NOx in the filtered mixture in the SCR catalyst canister 50. The chemical reduction reaction occurs in the SCR catalyst canister 50, and the products of the reaction, including nitrogen and water, are released into the atmosphere.

FIG. 2 is a schematic representation of one exemplary method for optimizing the operation of a diesel engine for cost. It is understood that one overall goal of the disclosure is to improve operational efficiency of diesel engine operation by reducing overall fluid consumption without adversely impacting emissions and/or performance standards. There are at least two inputs to the depicted method, fuel cost from engine and HC doser operation, and DEF cost, collectively termed cost data. In step 51, the cost data can be entered into the controller 75 using any method known in the art. The data can be stored in memory in table form or as maps, and may be user/owner programmable.

In step 52, the ECU 75 receives signals corresponding to the fuel cost and the DEF cost. Additionally, the ECU 75 may receive many other signals relating to various engine/vehicle sensors and executes control logic embedded in hardware and/or software to control various aspects of the engine 10. The computer readable storage media may, for example, include instructions stored thereon that are executable by the ECU 75 to perform methods of controlling all features and sub-systems in the engine 10. The program instructions may be executed by the ECU, and in the embodiment, specifically by the Motor Processing Unit (MPU) of the Electronic Control Unit (ECU) to control the various systems and subsystems of the engine and/or vehicle through the input/output ports. Furthermore, it is appreciated that any number of sensors and features may be associated with each feature in the system for monitoring and controlling the operation thereof

In step 53, using at least input fuel cost from engine operation, the DPF doser, or both, and input DEF cost and knowledge of the regulatory requirement for tailpipe NOx, a target engine-out NOx emissions value is determined. This means, given the government regulations, for cost purposes, it is determined what percentage of NOx reduction should be handled within the engine (for example, by EGR) and what percentage should be handled via aftertreatments (for example, by SCR).

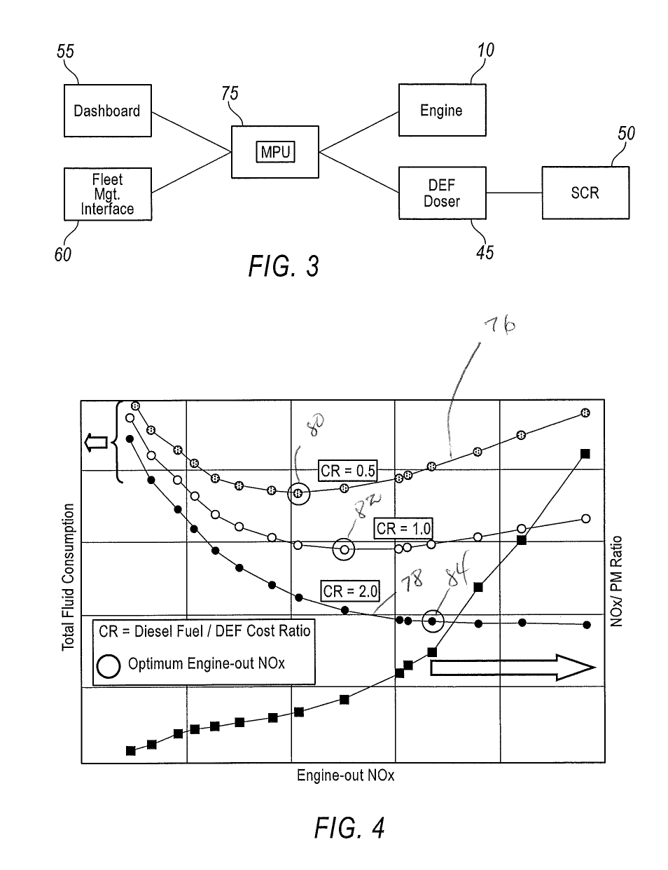

Once the optimal engine-out NOx emission level is determined step 53, the controller 75 directs step 61 by sending a signal, directly or indirectly, to the engine 10 to adjust the operating setpoints to generate the target engine-out NOx level. Step 61 can be performed because, as shown in FIG. 3, the controller 75 is in electronic communication with engine 10.

As seen in FIG. 2, the ECU 75 also directs step 62 by comparing the NOx level required by regulations to the target engine-out NOx. Using at least this comparison, the controller can determine how much DEF is to be injected or consumed in the SCR process so that the regulations can be satisfied. Next, the ECU 75 directs step 63 by sending signals, directly or indirectly, to the DEF doser to inject into the determined quantity of DEF into the exhaust stream. Steps 62 and 63 can be performed because, as shown in FIG. 3, the ECU 75 is in electrical communication with the DEF doser 45. Exhaust that passes through the DEF doser 45 is then immediately circulated through the SCR canister 50 and then released to atmosphere through the tailpipe.

FIG. 3 is an exemplary system for use with at least the method of FIG. 2. As seen therein, a vehicle dashboard 55 or a fleet management interface 60 may be used individually or in combination to enter fuel cost and DEF cost. The time of entry can be substantially simultaneous or it can differ. The only requirement for the input method or system is that such method or system must be in electronic communication with the ECU 75. In one non-limiting aspect of the present invention, the ECU 75 may be the DDEC controller available from Detroit Diesel Corporation, Detroit, Mich. Various other features of this controller are described in detail in a number of U.S. patents assigned to Detroit Diesel Corporation. Further, the controller may include any of a number of programming and processing techniques or strategies to control any feature of the engine 10 or aftertreatment devices. Moreover, more than one controller may be used, such as separate controllers for controlling system or sub-systems, including an exhaust system controller to control exhaust gas temperatures, mass flow rates, and other features associated therewith. In addition, these controllers may include controllers other than the DDEC controller described above.

The relationship of the cost ratio (CR) of diesel fuel to DEF at target engine-out NOx levels is depicted in FIG. 4. Generally, if prices fluctuate such that diesel fuel is expensive and DEF is inexpensive relative to one another, then the optimum engine-out NOx is relatively high and the percentage of the NOx emissions reductions that is performed in aftertreatment devices to achieve the government tailpipe regulations is also relatively high. This is because greater expenditure for reducing emissions will be done after the NOx is out of the engine using the relatively cheaper DEF as compared to diesel fuel. By way of a non limiting example, the CR of the fuel price and the DEF price may be determined by dividing the price of fuel per standard quantity (e.g. dollar cost per gallon, assuming standard fuel density and quantity) by the cost of the DEF per standard quantity (e.g. dollars per gallon). If the CR is 1, then the engine and the aftertreatment system (ATS) are operated within an optimal base strategy and NOx output level, to meet or exceed governmentally mandated NOx tailpipe levels. The DPF and other components of the aftertreament system may be regenerated as necessary.

If the CR is greater than 1, then the engine and SCR based aftertreatment system are operated with increased NOx engine output levels. This causes the engine controller to increase utilization of SCR based ATS system, and decrease time interval between regeneration intervals of DPF based ATS system to meet or exceed emissions regulations at requested engine power output level.

If the CR is less than 1, then the controller operates the engine with decreased NOx engine output levels, decrease utilization of SCR based ATS system and increase time between regeneration intervals of DPF based ATS system to meet or exceed emissions regulations at requested engine power output level.

As seen in FIG. 4, if prices fluctuate such that diesel fuel becomes relatively inexpensive in comparison to DEF, the optimum engine-out NOx 80, 82 and 84 may be substantially less so that more of the emissions reduction work is done in the engine with EGR rather than the expensive DEF. This would conserve the relatively expensive DEF used in SCR.

When the cost ratio (CR) of diesel fuel to DEF is 0.5 (CR=0.5) as seen at 76, the optimum engine-out NOx 80 is substantially lower than when the cost ratio of diesel fuel to DEF is 2.0 (CR=2.0) as seen at 78. It can also be seen that when the CR is 1.0, the optimum engine out NOx 82 is intermediate the optimum engine out NOx when CR is 0.5 and 2.0. The shift in optimum engine-out NOx from CR 0.5 to CR 2.0 may be more than 50%.

Note also that when the CR is higher, the NOx to particulate matter (PM) ratio is lower. This means there is less particulate matter to burn off of a DPF, resulting is less frequent regenerations which will inherently lower the diesel fuel consumption through an HC doser. The controller further accounts for the difference in engine output particulate matter accumulation on the DPF depending on the CR utilized.

The words used in this application are understood to be words of description, and are not words of limitation. While at least one method and system have been discussed, those skilled in the art recognize that many variations and modifications may be made without departing from the scope and spirit of the invention as set forth in the appended claims.

What is claimed as new and desired to be protected by Letters Patent of the United States is:

1. A method for operating a diesel engine equipped with an electronic control unit (ECU) with memory; said engine in fluid communication with at least one aftertreatment device to reduce NOx; said method comprising:
receiving input data regarding diesel fuel cost;
receiving input data regarding cost of diesel exhaust fluid;
determining a target engine-out NOx emission level based upon at least the diesel fuel cost input and the diesel exhaust fluid cost input;
determining a quantity of diesel exhaust fluid to be injected into the aftertreatment device; and
causing the determined quantity of diesel exhaust fluid to be injected into the aftertreatment device.

2. The method of claim 1, wherein said diesel fuel cost data input is received from a fleet management device in electronic communication with the controller.

3. The method of claim 1, wherein said diesel fuel cost data input is received from a vehicle dashboard device in communication with the controller.

4. The method of claim 1, wherein said diesel exhaust fluid cost data input is received from a fleet management device in communication with the controller.

5. The method of claim 1, wherein said diesel exhaust fluid cost data input is received from a vehicle dashboard device in communication with the controller.

6. The method of claim 1, wherein the aftertreatment device comprises a selective catalytic reduction system.

7. The method of claim 1, wherein the aftertreatment device comprises a diesel oxidation catalyst system.

8. The method of claim 1, wherein the aftertreatment device comprises a diesel particulate filter system.

9. An electronic control unit (ECU) for a diesel engine in fluid communication with an aftertreatment device for the reduction of NOx, said controller having instructions configured to receive input data regarding diesel fuel cost; receive input data regarding cost of diesel exhaust fluid; determine a desired engine-out NOx emission level based upon at least the diesel fuel cost input and the diesel exhaust fluid cost input; and determine a quantity of diesel exhaust fluid to be injected into the aftertreatment device.

10. The ECU of claim 9, wherein said diesel fuel cost data input is received from a fleet management device in communication with the electronic engine control module.

11. The ECU of claim 9, wherein said diesel fuel cost data input is received from a vehicle dashboard device in communication with the electronic engine control module.

12. The ECU of claim 9, wherein said diesel exhaust fluid cost data input is received from a fleet management device in communication with the electronic engine control module.

13. The ECU of claim 9, wherein said diesel exhaust fluid cost data input is received from a vehicle dashboard device in communication with the electronic engine control module.

14. The ECU of claim 9, further comprising an injection control system to inject the determined quantity of fuel into the aftertreatment device.

15. The ECU of claim 9, wherein the aftertreatment device includes a selective catalytic reduction system.

16. The ECU of claim 9, wherein the aftertreatment devices includes a diesel oxidation catalyst system.

17. The ECU of claim 9, wherein the aftertreatment devices includes a diesel particulate filter system.

18. A computer readable storage media configured with instructions to receive input data regarding diesel fuel cost; receive input data regarding cost of diesel exhaust fluid; determine a desired engine-out NOx emission level based upon at least the diesel fuel cost input and the diesel exhaust fluid cost input; and determine a quantity of diesel exhaust fluid to be injected into the aftertreatment device.
